(19) United States
(12) Patent Application Publication
(10) Pub. No.: US 2001/0002457 A1
(43) Pub. Date: May 31, 2001

(54) On-vehicle information system

(76) Inventors: Masaharu Umezu, Tokyo (JP); Tomoya Ikeuchi, Tokyo (JP); Yoshihisa Nakao, Hyogo (JP); Shoichiro Takenaka, Hyogo (JP); Satoshi Maegawa, Hyogo (JP); Makoto Mikuriya, Tokyo (JP); Mitsuo Shimotani, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/725,214

(22) Filed: Nov. 29, 2000

(30) Foreign Application Priority Data
Nov. 30, 1999 (JP) 11-341019

(51) Int. Cl. G01C 21/32

(52) U.S. Cl. 701/208; 340/995

(57) ABSTRACT

An on-vehicle information processor includes a map reader for reading map data from a map data storage in response to an application unit, a map manager provided with a map object generating unit for generating a map object of a format suitable for a request from an application, and a map object output unit for converting the map object thus generated into a format suitable for execution of the application before outputting the map object thus converted to the application unit.

### BACKGROUND OF THE INVENTION

1. Field of the Invention

The present invention generally relates to on-vehicle information processors for processing map information based on map data and, more particularly, to an on-vehicle information processor in which an application need not be modified even when the format of data is changed.

2. Description of the Related Art

FIG. 16 is a schematic diagram showing a on-vehicle information processor according to the related art. Referring to FIG. 16, the on-vehicle information processor comprises a map data storage means 101, a map manager 102 provided with a map reader for reading map data from the map data storage means 101, and a storage means 104 provided with application means 104a-104c for executing application programs that implement various services provided to users by processing the map data.

A description will now be given of the operation according to the related art.

When one of the application means 104a-104c requests the map manager 102 to provide map data, the map manager 102 reads out the map data from the map data storage means 101 via the map reader 103 so as to supply the requested map data to the requesting application means. For example, the application means 104a executes an application program that provides a service of displaying a road map, based on the map data thus supplied.

In the above-described construction of the related-art on-vehicle information processor, the map manager reads out the entire map data from the map data storage means and supply the map data to the application means whenever there is a request for map data from the application meas. Therefore, it is impossible to estimate a time required for the application means to process the data. The time required for processing is relatively long and the volume of data processed is relatively large. Accordingly, creating an application program is a relatively difficult task. Moreover, the related-art system has a drawback in that it is necessary to modify the application means when the format of the map data is changed.

### SUMMARY OF THE INVENTION

Accordingly, a general object of the present invention is to provide an on-vehicle information processor in which the aforementioned drawbacks are eliminated.

Another and more specific object is to provide an on-vehicle information processor that can be developed highly efficiently, in which a time required for the application means to process the data is properly estimated, in which it is not necessary to provide for exception handling needed when the processing time or the data volume is increased, in which the creation of an application program is relatively easy, in which the application means is isolated from a unit, such as a map manager, involved in map data access, and in which it is not necessary to modify the application means even when the format of map data stored in the map data storage means is changed.

The aforementioned objects can be achieved by an on-vehicle information processor comprising: map data storage means for storing map data; application means for executing an application program that serves a user requirement; a map reader for reading the map data from the map data storage means in response to a request from the application means; a map manager provided with map object generating means for generating a map object of a format suitable for the request; and map object output means for receiving the generated map object and converting the map object into a format suitable for execution of the application program and outputting the converted map object to the application means.

The aforementioned objects can also be achieved by an on-vehicle information processor comprising: map data storage means for storing map data; application means for executing an application program that serves a user requirement; map object generating means, provided in the application means, for generating a map object of a format suitable for a request from the application program; map object output means for receiving the generated map object and converting the map object into a format suitable for execution of the application program and outputting the converted map object to the application means; a map reader, provided in the map object output means, for reading the map data from the map data storage means.

A plurality of map objects of respective formats suitable for a plurality of corresponding requests from a plurality of application means may be generated from a single set of map data.

A single map object may be generated from a plurality of sets of map data of a single type or a plurality of types.

When data required by the application means is not found in the map data, the map object in which a preset value may be used as a necessary complement of the map data is generated.

When data unnecessary to the application means is found in the map data, the unnecessary data may be eliminated before generating the map object.

An object used for the purpose of mutual conversion of map objects between different application means may be generated.

The map object may be allowed to reflect externally provided information other than the map data.

The on-vehicle information processor may further comprise map data updating means for updating the map data in the map data storage means so that the map object is re-generated when the map data is updated by the map data updating means.

### BRIEF DESCRIPTION OF THE DRAWINGS

Other objects and further features of the present invention will be apparent from the following detailed description when read in conjunction with the accompanying drawings, in which:

FIG. 1 is a block diagram showing a construction of an on-vehicle information processor according to a first embodiment of the present invention;

FIG. 2 is a flowchart illustrating an operation according to the first embodiment;

FIG. 3 shows how map data is divided into areas spatially separated from one another;

FIGS. 4A-4D show formats of map object generated according to the first embodiment;

FIGS. 5A-5D show formats of low-level map objects acquired from respective map objects;

FIG. 6 is a block diagram showing a construction of an on-vehicle information processor according to a second embodiment of the present invention;

FIGS. 7A and 7B illustrate an operation according to a fourth embodiment of the present invention;

FIG. 8 is a block diagram showing a construction of an on-vehicle information processor according to a fifth embodiment of the present invention;

FIGS. 9A and 9B show node coordinates read out from a map data storage means and data obtained from a map object output means;

FIGS. 10A and 10B show road information of map data read out from the map data storage means and data obtained from the map object output means;

FIG. 11 is a block diagram showing a construction of an on-vehicle information processor according to a sixth embodiment of the present invention;

FIGS. 12A and 12B show node coordinates read out from a map data storage means and data obtained from a map object output means;

FIGS. 13A and 13B show conversion of map objects into one another occurring between applications;

FIG. 14 depicts conversion between application means; and

FIGS. 15A and 15B show how traffic information is reflected in the application means.

### DETAILED DESCRIPTION OF THE DRAWINGS

First embodiment

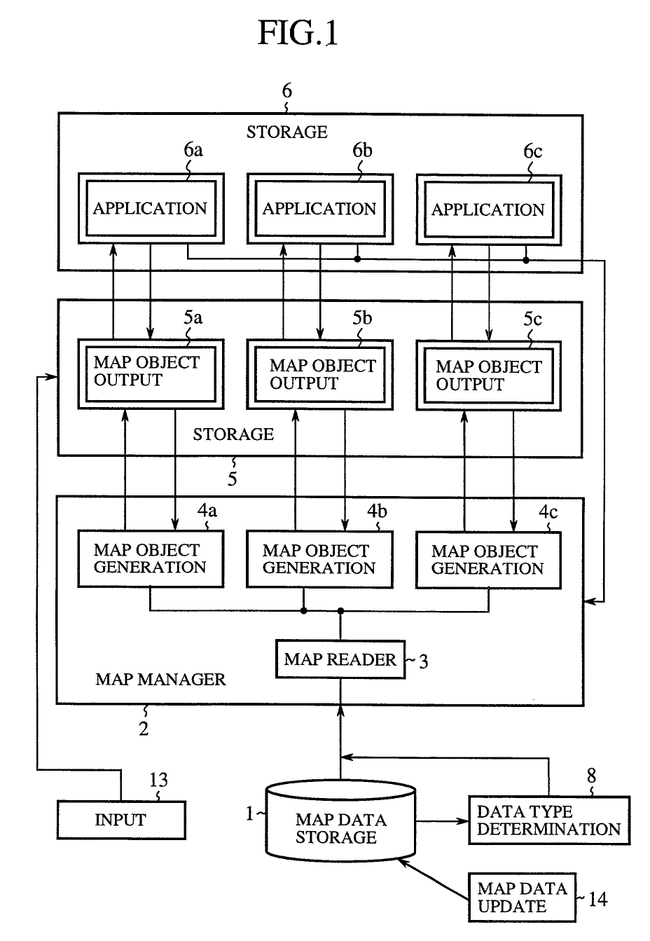

FIG. 1 is a block diagram showing a construction of an on-vehicle information processor according to a first embodiment of the present invention. The on-vehicle information processor comprises a map data storage means 1 for storing map data; a map manager 2 provided with a map reader 3 and map object generating means 4a-4c; a storage unit 5 storing map object output means 5a-5c for converting a map object supplied thereto into a format suitable for execution of an application program before outputting the map object; and a storage unit 6 storing application means 6a-6c for executing an application program each providing a service to a user by processing the map object.

A description will now be given of the operation according to the first embodiment.

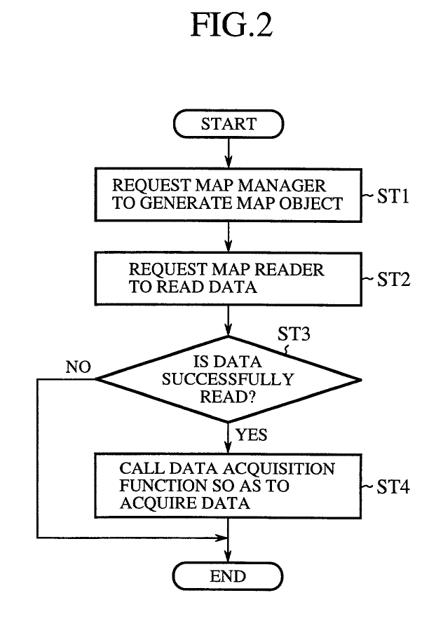

FIG. 2 is a flowchart illustrating the operation according to the first embodiment. When one of the application means 6a-6c requests the map manager 2 to generate a map object (step ST1), the map manager 2 requests the map reader 3 to read out map data from the map data storage means 1 (step ST2). Subsequently, a determination is made as to whether the map data is successfully read out by the map reader 3 from the map data storage means 1 (step ST3). If the determination yields a negative result, the operation is terminated. If a positive result is yielded, a corresponding one of the map object generating means 4a-4c in the map manager 2 calls a data acquisition function of the map object so as to acquire the data (step ST4). A corresponding one of the object output means 5a-5c converts the data into a format suitable for a program provided by a corresponding one of the application means 6a-6c, before terminating the operation.

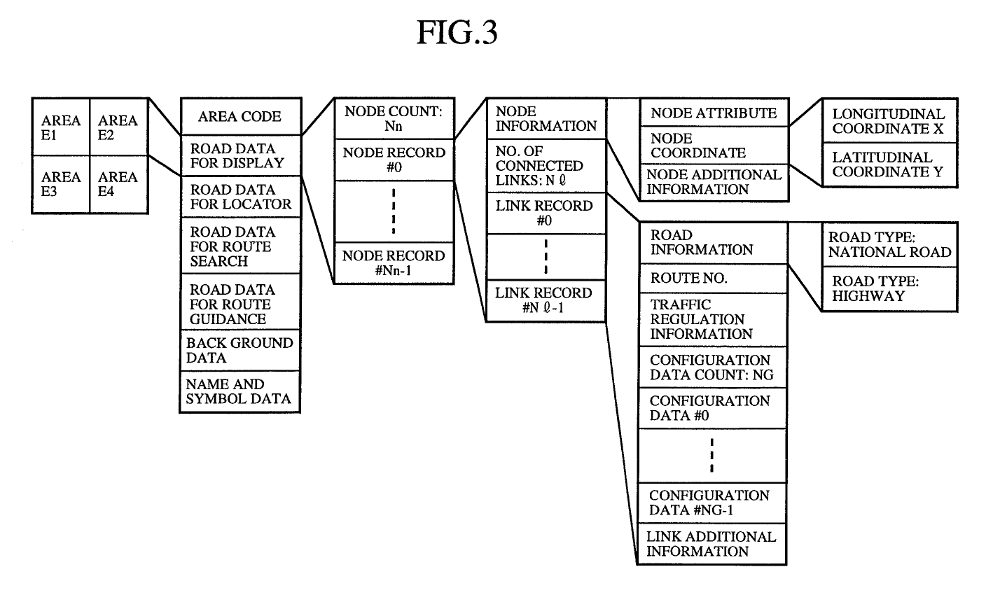

As shown in FIG. 3, the map data is divided into geographical areas E1-E4. The object for each area comprises individual objects successively generated in a tree-like manner. For example, the map object for area E2 is comprised of displayed road data, road data for a locator, road data for route search, road data for route guidance, background data and name and symbol data. The displayed road data comprises node count N, node records #0-#Nₙ₋₁. The node record #0 further comprises node information, number of connected links N1, link records #0-#Nₗ₋₁.

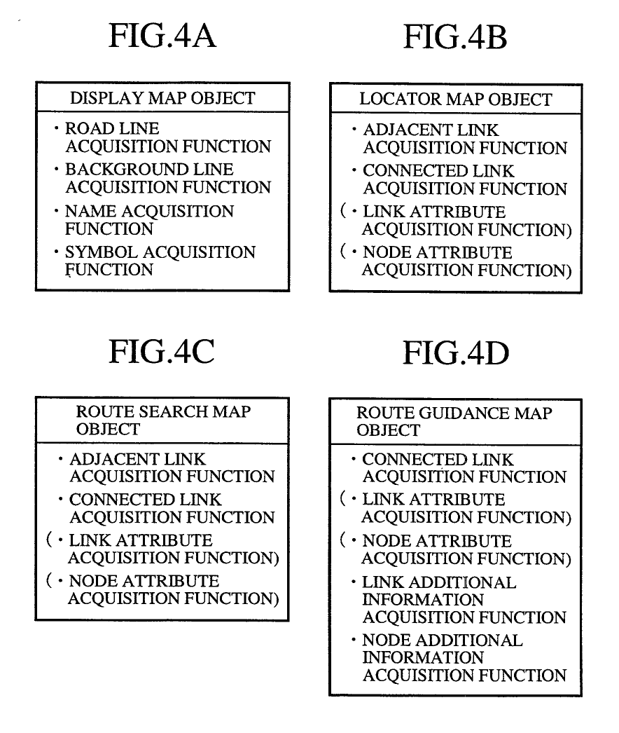

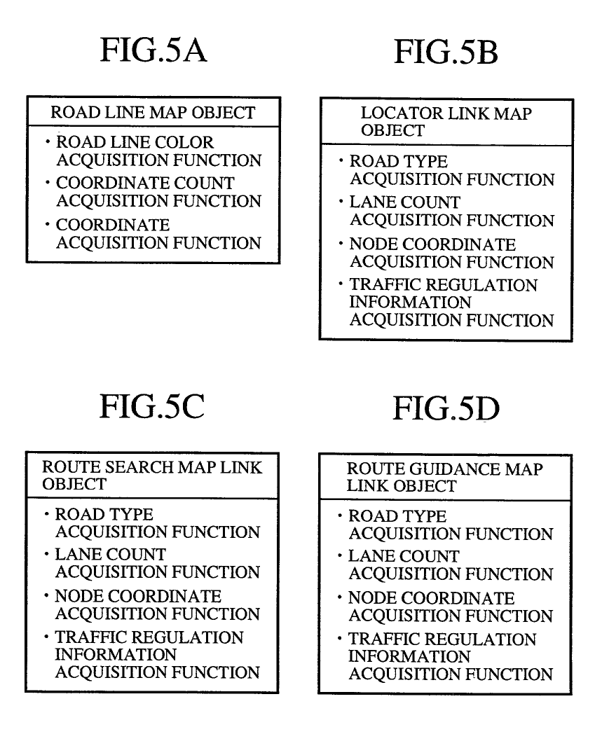

FIGS. 4A-4D show map objects generated according to the first embodiment. A displayed map object shown in FIG. 4A, a locator map object shown in FIG. 4B, a route search map object shown in FIG. 4C or a route guidance map object shown in FIG. 4D may be generated depending on the application. FIGS. 5A-5D show map objects corresponding to a function in the corresponding map object shown in FIGS. 4A-4D.

According to the first embodiment, the application means 6a-6c access the map object output means 5a-5c, respectively, so as to acquire the data for the corresponding area in the form of a map object. The time required for the application means 6a-6c to process the data can be estimated properly. It is not necessary to provide for exception handling which is needed when the processing time or the data volume is increased. Generation of application programs that implement various services is facilitated. By separating a unit accessing the map data from the application means 6a-6c, and employing the map object output means, an inexpensive on-vehicle information processor that can be developed highly efficiently, in which the application means 6a-6c can remain unaffected even when the format of map data is changed, is available.

Second embodiment

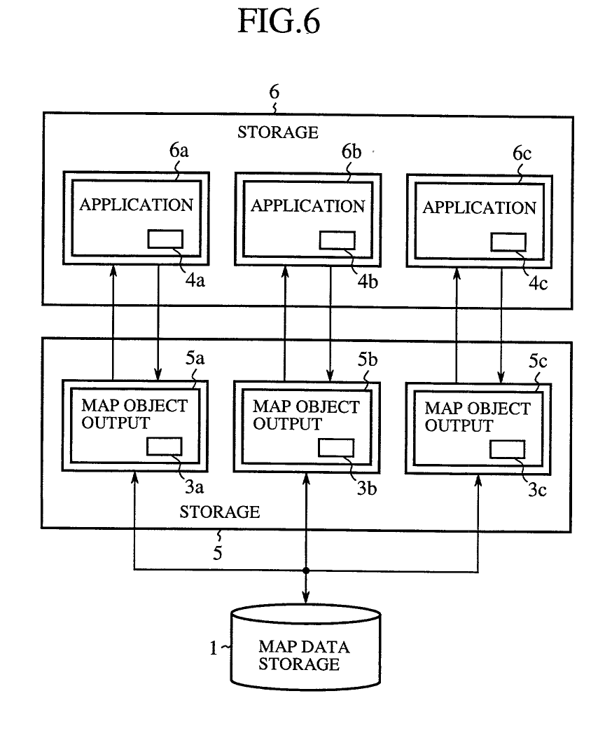

FIG. 6 is a block diagram showing the construction of an on-vehicle information processor according to a second embodiment of the present invention. The map manager 2 in the first embodiment shown in FIG. 1 is eliminated. Map readers 3a-3c are provided in the map object output means 5a-5c, respectively. Map object generating means 4a-4c are provided in the application means 6a-6c, respectively. The other aspects of the construction are the same as the corresponding aspects according to the first embodiment so that the description thereof is omitted.

A description will now be given of the operation according to the second embodiment.

When one of the application means 6a-6c requests a corresponding one of the map object output means 5a-5c to generate a map object, a corresponding one of the map reader 3a-3c reads the map data from the map data storage means 1 and supplies the same to a corresponding one of the object generating means 4a-4c. The object generating means supplied with the map data generates a map object adapted to the request from the application means and having a format shown in FIGS. 3-5D. The map object thus generated is supplied to the corresponding one of the map object output means 5a-5c.

According to the second embodiment, the map manager is not necessary so that the software configuration is simplified. It is thus possible to make available a relatively inexpensive on-vehicle information processor providing an advantage similar to that of the first embodiment using a relatively small number of components.

Third embodiment

According to the third embodiment, a single road data set is used to generate the displayed map object, the locator map object, the route search map object and the route guidance map object. With this construction, it is not necessary to provide map data corresponding to individual applications, thus reducing an external storage volume and a memory size required.

Fourth embodiment

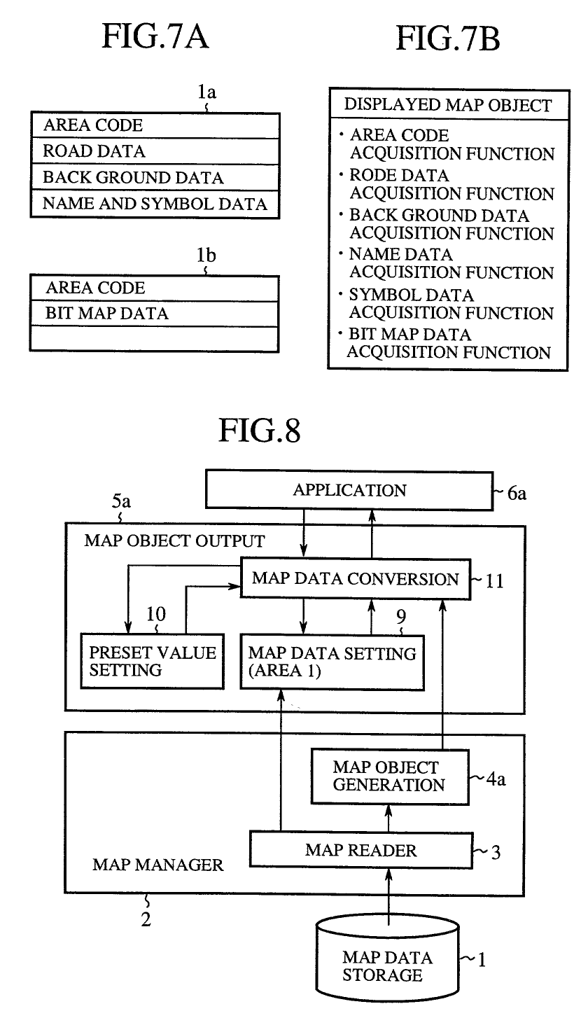

FIG. 7 illustrates the operation according to a fourth embodiment. According to the fourth embodiment, a plurality of map data sets 1a, 1b . . . are used to generate a single map object. Referring to FIG. 7A, the map data set 1a comprises an area code, map data, background data, and name and symbol data shown in FIG. 3. The map data set 1b comprises an area code and a bit map data. FIG. 7B shows a map object generated from the map data sets 1a and 1b. The map object shown in FIG. 7B is formed of an area code acquisition function, a road data acquisition function, a background data acquisition function, a name data acquisition function, a symbol data acquisition function and a bit map data acquisition function.

According to the fourth embodiment, a plurality of map data sets are used to form a map object adapted to the requirement of an application.

Fifth embodiment

FIG. 8 is a block diagram showing a construction of an on-vehicle information processor according to a fifth embodiment of the present invention. FIG. 8 shows connections involving the application means 6a. Referring to FIG. 8, the map manager 2 is provided with the map reader 3 and the map object generating means 4a. The map object output means 5a is provided with a map data setting means 9, a preset value setting means 10 and a map data converting means 11.

A description will now be given of the operation according to the fifth embodiment.

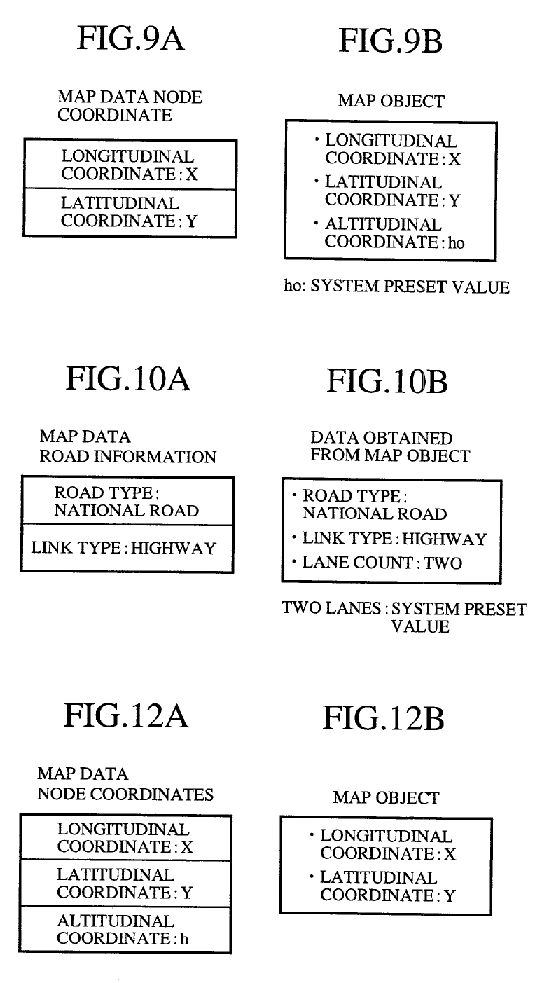

The map reader 3 reads out the map data shown in FIG. 9A from the map data storage means 1 and supplies the map data to the map data setting means (area 1) 9. The map object generated by the map object generating means 4a is provided to the map data converting means 11. The node coordinate data of the map object is formed as two-dimensional data comprising a longitudinal coordinate and a latitudinal coordinate. The map data converting means 11 reads out a preset value from the preset value setting means 10 so as to use the preset value as an altitudinal coordinate in an output map object. The map data converting means 11 outputs the map object shown in FIG. 9B.

The map reader 3 may read map data shown in FIG. 10A comprising road information, road type (national road) and link type (highway). The map reader 3 supplies the map data thus read to the road data setting means (area 1) 9. The map object generated in the map object generating means 4a is supplied to the map data converting means 11. The map object supplied to the map data converting means 11 comprises the road type and the link type. The map data converting means 11 reads out a preset value from the preset value setting means 10 so as to use the preset value as a lane count in an output map object. The map data converting means 11 outputs the map object shown in FIG. 10B.

As has been described, according to the fifth embodiment, even when the information required by the application means is not found in the map data, the map object required by the application can be generated. Thus, the on-vehicle system can operate without modifying the application.

Sixth embodiment

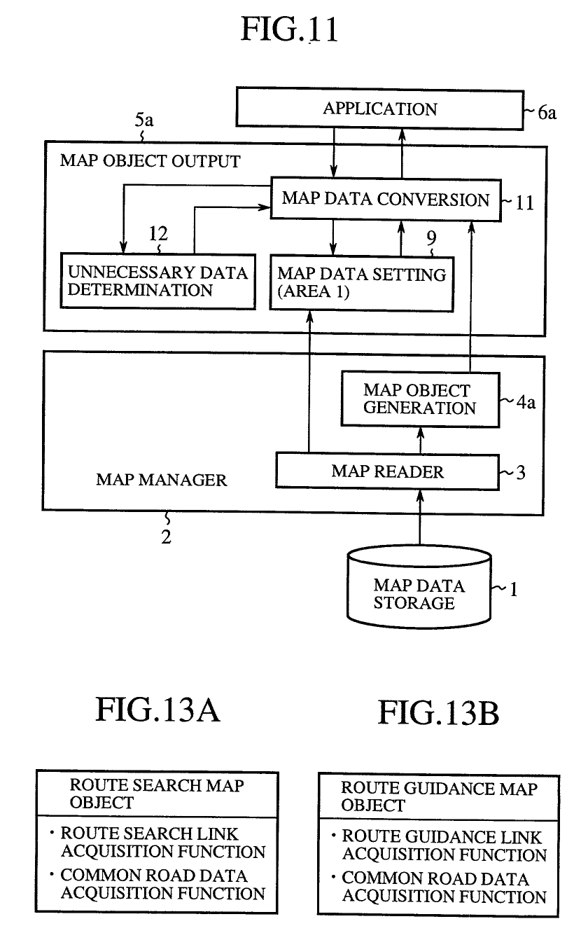

FIG. 11 is a block diagram showing a construction of an on-vehicle information processor according to a sixth embodiment of the present invention. More specifically, FIG. 11 shows connections involving the application means 6a. Referring to FIG. 11, the map manager 2 is provided with the map reader 3, the map object generating means 4a. The map object output means 5a is provided with the map data setting means (area 1) 9, the unnecessary data determining means 12 and the map data converting means 11.

A description will now be given of the operation according to the sixth embodiment.

The map reader 3 reads out the map data shown in FIG. 12A comprising node coordinates and supplies the node coordinates thus read out to the map data setting means (area 1) 9. The map object generated in the map object generated means 4a is supplied to the map data converting means 11. The node coordinates supplied to the map data converting means 11 comprises the longitudinal coordinate, the latitudinal coordinate and the altitudinal coordinate. The map data converting means 11 notifies the unnecessary data determining means 12 of the receipt of the data. The map data converting means 11 learns of the data not to be delivered to the application means 6a from the unnecessary data determining means 12. The map data converting means 11 supplies, to the application means 6a, the map object shown in FIG. 12B in which object the unnecessary data, i.e. the altitudinal data, is eliminated.

As has been described, according to the sixth embodiment, when the map data comprises information not required by the application means, the unnecessary information is eliminated before generating the map object. Accordingly, the system can operate without modifying the application means. Elimination of the unnecessary information also eliminates the need for some memory space.

Seventh embodiment

By representing the node coordinate constituting the locator link map object shown in FIG. 5B, the node coordinate constituting the route search map link object shown in FIG. 5C and the node coordinate constituting the route guidance link object shown in FIG. 5D using a common node coordinate object, the listed objects can share the coordinate information by conversion.

FIGS. 13A and 13B show conversion of the route search map object and the route guidance map object occurring between applications. A common road data object is defined as an object subject to conversion between applications. The route search link acquisition function for acquiring the route search data from the common road data and the common road data acquisition function for acquiring the common road data from the route search data are added to the route search map object. The route guidance link acquisition function for acquiring the route guidance data from the common road data and the common road data acquisition function for acquiring the common road data from the route search data are added to the route guidance map object. With this construction, the route search link and the route guidance link can be converted into one another.

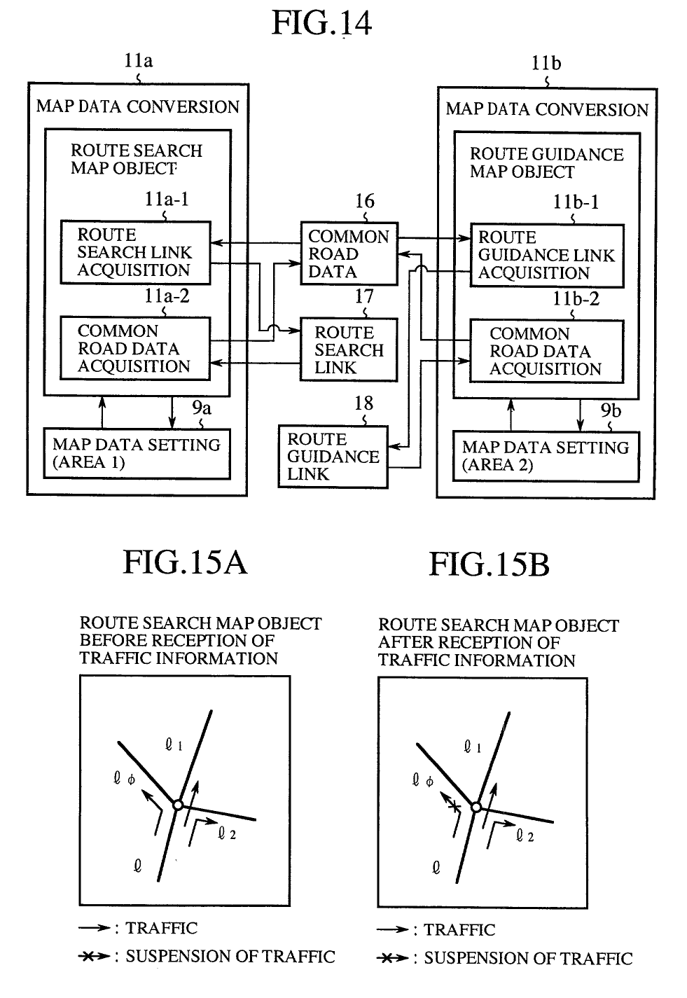

FIG. 14 illustrates how a conversion between applications takes place. Referring to FIG. 14, the route search map object is a map object primarily used by an application means for route search for searching for a route to a destination. The route search link denotes a road network. More specifically, the application means for route search acquires the route search link from the map object output means for route search so as to generate a route to the destination.

The route guidance map object is a map object for visually or audibly guiding a driver to the destination along the route generated by the application means for route search. Like the route search link, the route guidance link denotes the road network. The route guidance link is more detailed than the route search link. The application means for route guidance acquires the route guidance link from the map data converting means for route guidance.

The common road data obtains the route guidance link from the route search link and also obtains the route search link from the route guidance link.

A map data converting means 11a is provided with a route search link acquiring means 11a-1 for acquiring the route search link from a common road data 16, a common road data acquiring means 11a-2 for acquiring the common road data from a route search link 17, and a map data setting means 9a. A map data converting means 11b is provided with a route guidance link acquiring means 11b-1 for acquiring a route guidance link 18 from the common road data 16, a common road data acquiring means 11b-2 for acquiring the common road data 16 from the route guidance link 18, and a map data setting means 9b. With this construction, the route search link 17 and the route guidance link 18 can be converted into one another via the common road data 16.

In the description given above, the map data converting means 11a associated with the map object generating means 4a and the map data converting means 11b associated with the map object generating means 4b are given as examples. Mutual conversion with respect to the locator link of the locator map object or the road data of the displayed map object may also be possible.

As described above, according to the seventh embodiment, by defining data subject to mutual conversion that occurs between map data converting means associated with respective map object generating means, mutual conversion can occur more efficiently between a plurality of map data converting means than when individual converting means are provided. Mutual conversion can also be performed when a map object adapted for a new function.

Eighth embodiment

Information such as traffic information, time information, vehicle type information, personal information or weather information may be provided via an input means 13 shown in FIG. 1 to the map object output means 5a-5c so that the input information may be reflected in the map object.

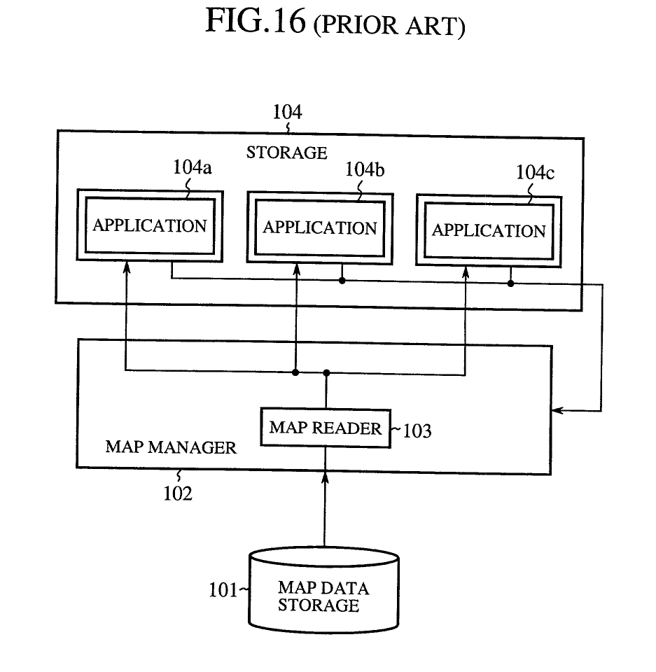

In the illustrated example of FIGS. 15A and 15B, the traffic information input via a traffic information receiving means embodying the input means 13 is used. FIG. 15A shows how a route search map object is used in a display before the traffic information is received. When the traffic information indicating that the traffic on Route l₀ is suspended, the input information related to Route l₀ is reflected in the map object as shown in FIG. 15B.

As described, according to the eighth embodiment, by allowing traffic information, time information, vehicle type information, personal information and weather information to be reflected in the map object, the content of map objects corresponding to the respective application means can be richer in information.

Ninth embodiment

Referring to FIG. 1, when the content of storage in the map data storage means 1 is updated by a map data updating means 14, a map data type determining means 8 determines that the data subsequent to the update is different from the previous data. In this case, the current map object is discarded so that the map object adapted for the current map data is generated.

The present invention is not limited to the above-described embodiments, and variations and modifications may be made without departing from the scope of the present invention.

What is claimed is:

1. An on-vehicle information processor comprising:
map data storage means for storing map data;
application means for executing an application program that serves a user requirement;
a map reader for reading the map data from said map data storage means in response to a request from said application means;
a map manager provided with map object generating means for generating a map object of a format suitable for the request; and
map object output means for receiving the generated map object and converting the map object into a format suitable for execution of the application program and outputting the converted map object to said application means.

2. An on-vehicle information processor comprising:
map data storage means for storing map data;
application means for executing an application program that serves a user requirement;
map object generating means, provided in said application means, for generating a map object of a format suitable for a request from the application program;
map object output means for receiving the generated map object and converting the map object into a format suitable for execution of the application program and outputting the converted map object to said application means;
a map reader, provided in said map object output means, for reading the map data from said map data storage means.

3. The on-vehicle information processor according to claim 1, wherein a plurality of map objects of respective formats suitable for a plurality of corresponding requests from a plurality of application means are generated from a single set of map data.

4. The on-vehicle information processor according to claim 2, wherein a plurality of map objects of respective formats suitable for a plurality of corresponding requests from a plurality of application means are generated from a single set of map data.

5. The on-vehicle information processor according to claim 1, wherein a single map object is generated from a plurality of sets of map data of a single type or a plurality of types.

6. The on-vehicle information processor according to claim 2, wherein a single map object is generated from a plurality of sets of map data of a single type or a plurality of types.

7. The on-vehicle information processor according to claim 1, wherein when data required by said application means is not found in the map data, the map object in which a preset value is used as a necessary complement of the map data is generated.

8. The on-vehicle information processor according to claim 2, wherein when data required by said application means is not found in the map data, the map object in which a preset value is used as a necessary complement of the map data is generated.

9. The on-vehicle information processor according to claim 1, wherein when data unnecessary to said application means is found in the map data, the unnecessary data is eliminated before generating the map object.

10. The on-vehicle information processor according to claim 2, wherein when data unnecessary to said application means is found in the map data, the unnecessary data is eliminated before generating the map object.

11. The on-vehicle information processor according to claim 1, wherein an object used for the purpose of mutual conversion of map objects between different application means is generated.

12. The on-vehicle information processor according to claim 2, wherein an object used for the purpose of mutual conversion of map objects between different application means is generated.

13. The on-vehicle information processor according to claim 1, wherein the map object is allowed to reflect externally provided information other than the map data.

14. The on-vehicle information processor according to claim 2, wherein the map object is allowed to reflect externally provided information other than the map data.

15. The on-vehicle information processor according to claim 1, further comprising map data updating means for updating the map data in said map data storage means so that the map object is re-generated when the map data is updated by said map data updating means.

16. The on-vehicle information processor according to claim 2, further comprising map data updating means for updating the map data in said map data storage means so that the map object is re-generated when the map data is updated by said map data updating means.
